(19) United States
(12) Patent Application Publication
(10) Pub. No.: US 2008/0192473 A1
(43) Pub. Date: Aug. 14, 2008

(54) Fooldlight With Variable Beam

(75) Inventor: Remi Noirot, Amberieux en Dombes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/599,299

(22) PCT Filed: Mar. 23, 2005
(86) PCT No.: PCT/IB05/50993

§ 371 Date: Sep. 25, 2006

(30) Foreign Application Priority Data
Mar. 29, 2004 (EP) 04300168.4

(51) Int. Cl. F21S 8/00

(52) U.S. Cl. 362/277

(57) ABSTRACT

The invention relates to a floodlight comprising means (101) for generating a convergent beam having a central axis, and a lens (102) located substantially around the central axis. The floodlight comprises means for moving the lens with respect to the generating means.

### FIELD OF THE INVENTION

The present invention relates to a floodlight intended to be used in various applications.

The present invention is particularly relevant for stage, facade or accent lighting.

### BACKGROUND OF THE INVENTION

In the field of lighting, various kinds of beams are often required. For instance, when a facade is to be illuminated, a wide beam may be desired, so as to illuminate the whole facade. Alternatively, a narrow beam may be desired, so as to illuminate only a part of the facade. To this end, different floodlights have to be used. The company Fraen for example proposes floodlights comprising a collimator and a micro-lens array in front of the collimator. In order to modify the beam provided by such a floodlight, the micro-lens array and the collimator have to be replaced. A complete range of floodlights thus has to be manufactured, which is complex for the manufacturer and not very flexible for a user who needs different floodlights for different lighting applications. Moreover, the replacement of a collimator and a micro-lens array requires a long and complicated process.

### SUMMARY OF THE INVENTION

It is an object of the invention to provide a floodlight which can provide various beams without the need to replace any component.

To this end, the invention proposes a floodlight comprising means for generating a convergent beam having a central axis, and a lens located substantially around said central axis, the floodlight comprising means for moving said lens with respect to said generating means.

According to the invention, various beams are obtained in that the lens located on the path of the convergent beam is moved. The floodlight in accordance with the invention thus does not require replacement of any component in order to provide various beams.

In a first embodiment of the invention, the moving means are adapted to move said lens in a direction parallel to said central axis. A movement of the lens in said direction will modify the width of the beam. This embodiment thus allows obtaining various beams having various widths, only in that the lens located on the path of the convergent beam is moved in a direction parallel to said beam.

In a second embodiment of the invention, the moving means are adapted to move said lens in a direction perpendicular to said central axis. A movement of the lens in said direction will modify the beam tilt, i.e. the angle of the beam at the exit of the floodlight. This embodiment thus allows rotating the beam provided by the floodlight, without rotating the floodlight, as is required in the prior art.

Advantageously, the floodlight comprises means for generating at least a first and a second convergent beam having a first and a second central axis, and a first and a second lens located substantially around the first and the second central axis respectively, the floodlight comprising means for moving said first and said second lens with respect to said generating means. The use of a plurality of lenses reduces the size of each lens that is used in the floodlight. As a consequence, the displacement of the lenses that is required in order to obtain a desired beam at the exit of the floodlight is reduced, as will be explained in the detailed description.

Preferably, the means for generating at least the first and the second convergent beam comprise a light source, collimating means, a first and a second convergent lens. The use of a single light source for a plurality of convergent lenses makes it possible to obtain a homogeneous luminous flux on each convergent lens. As a consequence, the luminous flux of the beam obtained with the floodlight is homogeneous, which would not be the case with a single light source associated to a single convergent lens, in case the flux is not homogeneous on said single convergent lens. This reduces artifacts in the beam at the exit of the floodlight.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIGS. 1a, 1b and 1c show a floodlight in accordance with a first embodiment of the invention, in three different applications;

FIGS. 2a, 2b and 2c show a floodlight in accordance with a second embodiment of the invention, in three different applications;

FIGS. 3a, 3b and 3c show a floodlight in accordance with a preferred embodiment of the invention, in three different applications;

FIGS. 4a, 4b and 4c show a floodlight in accordance with another embodiment of the invention, in three different applications.

### DETAILED DESCRIPTION OF THE INVENTION

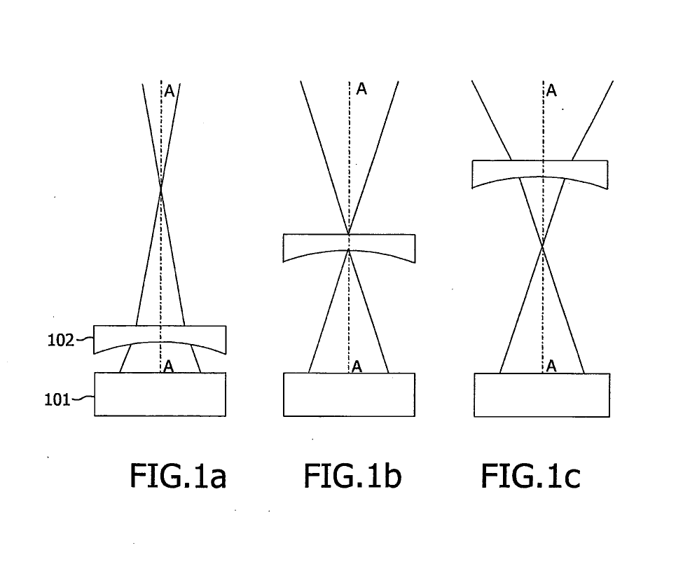

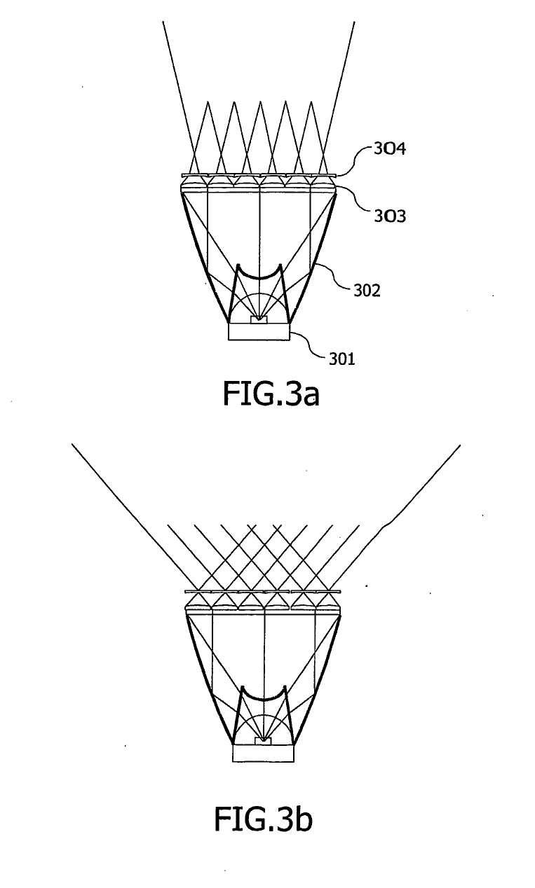

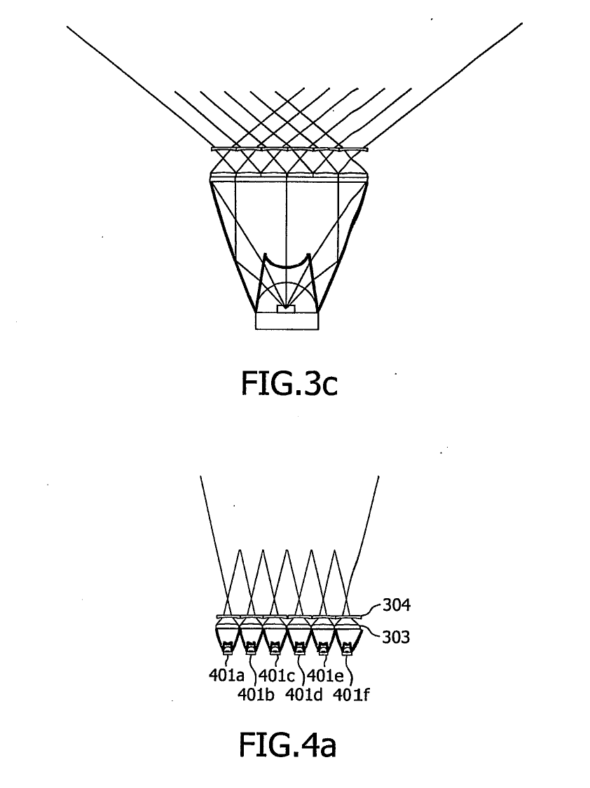

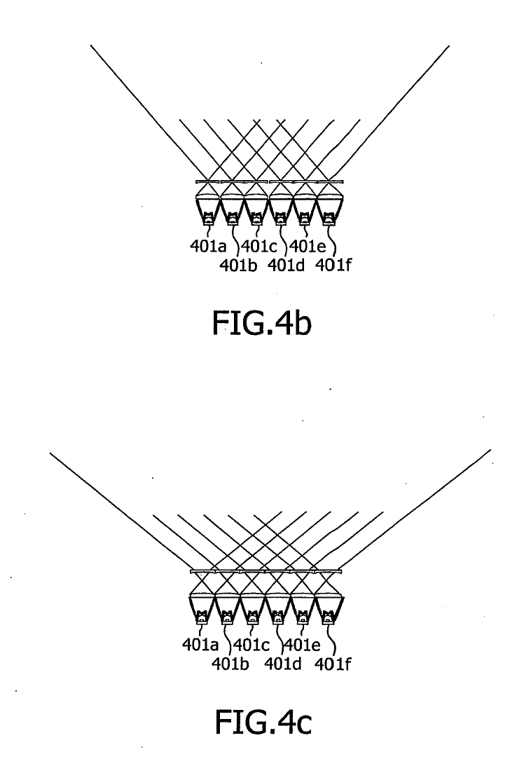

A floodlight in accordance with a first embodiment of the invention is depicted in FIGS. 1a to 1c. This floodlight comprises means 101 for generating a convergent beam, and a lens 102. The convergent beam has a central axis AA and the lens is located substantially around said central axis AA. In the example of FIGS. 1a to 1c, the lens 102 is located exactly around the central axis AA, which means that the center of the lens 102 is on the central axis AA. The generating means 101 can be any means adapted for generating a convergent beam. For example, a light source with an elliptic reflector can generate a convergent beam. Another example of generating means 101 is described in FIGS. 3a to 4c.

The floodlight further comprises means for moving the lens 102, which are not shown on FIGS. 1a to 1c. In FIG. 1a, the lens 102 is located before the point where the rays of the convergent beam generated by the generating means 101 converge. The lens 102 is in this example a plano-concave lens, i.e. a divergent lens. However, a convergent lens could also be used without departing from the scope of the invention. As can be seen in FIG. 1a, a relatively narrow beam is obtained. In FIG. 1b, the lens 102 is located on the point where the rays of the convergent beam generated by the generating means 101 converge. The beam is thus not modified by the lens 102, and a medium beam is obtained, as can be seen in FIG. 1b. In FIG. 1c, the lens 102 is located beyond the point where the rays of the convergent beam generated by the generating means 101 converge. A relatively large beam is obtained, as can be seen in FIG. 1c.

By modification of the position of the lens 102 with respect to the generating means 101, the width of the beam at the exit of the floodlight can thus be modified. This is achieved in that the lens 102 is moved in a direction parallel to the central axis AA of the convergent beam generated by the generating means 101.

A convergent lens could be used instead of the divergent lens 102. However, a divergent lens is preferred in this first embodiment, because it avoids ghost beams which could be obtained by use of a convergent lens. Instead of a spherical or aspherical lens 102, a cylindric lens can be used. This allows obtention of linear beams.

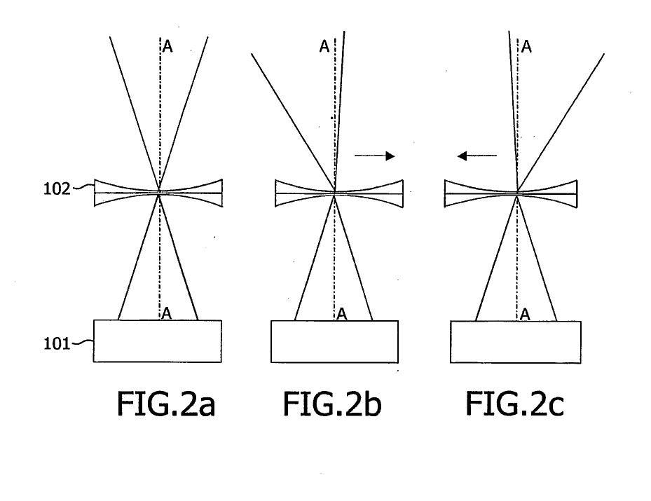

A floodlight in accordance with a second embodiment of the invention is depicted in FIGS. 2a to 2c. This floodlight comprises the generating means 101, and the lens 102. The lens 102 is in this example a bi-concave lens, i.e. a divergent lens. However, a convergent lens, such as a bi-convex lens, could also be used with exactly the same results. In this example, the lens 102 is located on the point where the rays of the convergent beam generated by the generating means 101 converge. However, the lens could be placed before or beyond this point, with the same results.

In this second embodiment, the moving means are adapted to move the lens 102 in a direction perpendicular to the central axis AA. In FIG. 2a, the center of the lens 102 is on the central axis AA. The convergent beam is thus not modified. In FIG. 2b, the lens 102 has been moved such that the center of the lens 102 is located on the right of the central axis AA. The beam is thus deviated to the left, as can be seen in FIG. 2b. In FIG. 2c, the lens 102 has been moved such that the center of the lens 102 is located on the left of the central axis AA. The beam is thus deviated to the right, as can be seen in FIG. 2c.

In the example of FIGS. 2b and 2c, the lens 102 is not located exactly around the central axis AA. However, a relatively large part of the lens 102 is located around said central axis AA, which means that the lens 102 is located substantially around the central axis AA. It can be considered that the lens 102 is located substantially around the central axis AA when at least a portion of the lens 102 is located on the central axis AA. This ensures that the convergent beam falls on a relatively small portion of the lens 102, so that a prismatic deviation occurs.

By modification of the position of the lens 102 with respect to the generating means 101, the beam tilt can thus be modified. The beam at the exit of the floodlight can thus be oriented without the need to rotate the floodlight. This is achieved in that the lens 102 is moved in a direction perpendicular to the central axis AA of the convergent beam generated by the generating means 101. As in FIGS. 1a to 1c, a cylindrical lens 102 can be used instead of a spherical or aspherical lens.

A floodlight in accordance with a preferred embodiment of the invention is depicted in FIG. 3a. This floodlight comprises a light source 301, collimating means 302, a convergent lenses array 303 and a divergent lenses array 304. The convergent lenses array 303 comprises a plurality of convergent lenses. Each lens of the convergent lenses array 303, in combination with the collimating means 302, forms means for generating a convergent beam.

The collimating means 302 are adapted for generating a parallel beam from the beam generated by the light source 301. In the example of FIGS. 3a to 3c, the light source 301 is a LED, but any light source may be used in combination with a parabolic reflector. Such collimating means 302 are well known to those skilled in the art. For example, a collimator of the type commercialized by Fraen under reference FHS-HNB1-LB01-x is adapted for generating a parallel beam.

When the parallel beam passes through the convergent lenses array 303, a plurality of convergent beams is generated. The divergent lenses array 304 is such that each lens of the divergent lenses array 304 is located substantially around one of the central axes of the various convergent beams, as can be seen in FIGS. 3a to 3c.

In FIG. 3a, the divergent lenses array 304 is located before the plane where the rays of the convergent beams converge. In FIG. 3b, the divergent lenses array 304 is located on this plane and in FIG. 3c, the divergent lenses array 304 is located beyond this plane. As can be seen in FIGS. 3a to 3c, and for the reasons explained in FIGS. 1a to 1c, different widths of the beam at the exit of the floodlight are thus obtained.

A floodlight such as the one described in FIG. 3b for example can be used for generating beams with various beam tilts. To this end, the divergent lenses array 304 is replaced by an array comprising lenses as described in FIGS. 2a to 2c, and the resulting divergent lenses array is moved in a direction parallel to this array.

A floodlight with a plurality of lenses has an advantage over a floodlight with one lens. Actually, for a same size of floodlight, the size of the lenses will be lower when a plurality of lenses is used. Now, various beam widths are obtained in FIGS. 3a to 3c in that the position of the divergent lenses array 304 is adjusted with respect to the plane where the rays of the convergent beams converge. This plane is defined by the focal distance of the convergent lenses of the convergent lenses array 303. This focal distance decreases with the size of the convergent lenses. As a consequence, the smaller the lenses, the smaller the needed displacement of the divergent lenses array 304. A floodlight that uses a plurality of lenses will thus be more compact than a floodlight using only one lens.

FIGS. 4a to 4c show another floodlight in accordance with the invention. This floodlight comprises means for generating a collimated beam 401a to 401f. Each means for generating a collimated beam comprises a light source and collimating means, such as the light source 301 and the collimating means 302 of FIGS. 3a to 3c. In the example depicted in FIGS. 4a to 4c, six collimated beams are generated. The floodlight comprises the convergent lenses array 303 and the divergent lenses array 304. In this example, one of the lenses of the convergent lenses array 303, in combination with one of the means for generating a collimated beam 401a to 401f, forms means for generating a convergent beam. As shown in FIGS. 4a to 4c, different beam widths are obtained in that the divergent lenses array 304 is moved with respect to the means for generating the convergent beams.

A floodlight such as the one described in FIG. 4b for example can be used for generating beams with various beam tilts. To this end, the divergent lenses array 304 is replaced by an array comprising lenses as described in FIGS. 2a to 2c, and the resulting divergent lenses array is moved in a direction parallel to this array.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A floodlight comprising means (101) for generating a convergent beam having a central axis (AA), and a lens (102) located substantially around said central axis, the floodlight comprising means for moving said lens with respect to said generating means.

2. A floodlight as claimed in claim 1, wherein said moving means are adapted to move said lens in a direction parallel to said central axis.

3. A floodlight as claimed in claim 1, wherein said moving means are adapted to move said lens in a direction perpendicular to said central axis.

4. A floodlight as claimed in claim 1, said floodlight comprising means (301, 302, 303) for generating at least a first and a second convergent beam having a first and a second central axis, and a first and a second lens (304) located substantially around the first and the second central axis respectively, the floodlight comprising means for moving said first and said second lens with respect to said generating means.

5. A floodlight as claimed in claim 1, wherein said means for generating a convergent beam comprise a light source (301), collimating means (302) and a convergent lens.

6. A floodlight as claimed in claim 4, wherein said means for generating at least the first and the second convergent beam comprise a light source, collimating means, a first and a second convergent lens.
